(19) United States
(12) Patent Application Publication
(10) Pub. No.: US 2018/0114205 A1
(43) Pub. Date: Apr. 26, 2018

(54) DISTRIBUTED LEDGER SYSTEM FOR PROVIDING AGGREGATE TRACKING AND THRESHOLD TRIGGERING

(71) Applicant: BANK OF AMERICA CORPORATION, Charlotte, NC (US)

(72) Inventors: Richard Huw Thomas, Charlotte, NC (US); Joseph Benjamin Castinado, North Glenn, CO (US)

(21) Appl. No.: 15/350,930

(22) Filed: Nov. 14, 2016

Related U.S. Application Data
(60) Provisional application No. 62/411,236, filed on Oct. 21, 2016.

(51) Int. Cl. G06Q 20/10; G06Q 40/02; G06Q 20/40

(52) U.S. Cl. CPC G06Q 20/102; G06Q 20/40; G06Q 40/02

(57) ABSTRACT

Embodiments provide a system operatively connected with a block chain distributed network and for using the network for providing aggregate tracking and threshold triggering. Embodiments receive, at a node of a blockchain distributed network, an interaction record associated with an interaction between a payor entity and a payee entity. The system accesses and updates a distributed ledger based on communications from the block chain and determines, from the distributed ledger, a net position between the entity and a third party. If the entity is the payor entity and the third party is the payee entity, the system debits the net position in the amount of the interaction; however, if the entity is the payee entity and the third party is the payor entity, the system credits the net position in the amount of the interaction. The system then updates and records an updated net position on the distributed ledger.

### CROSS-REFERENCE TO RELATED APPLICATIONS

This application claims the benefit of U.S. Provisional Application Ser. No. 62/411,236, entitled “DISTRIBUTED LEDGER SYSTEM FOR PROVIDING AGGREGATE TRACKING AND THRESHOLD TRIGGERING”, filed Oct. 21, 2016, which is incorporated herein by reference in its entirety.

### BACKGROUND

Most settlement networks (EWS, TCH, debit networks) rely on a proprietary central clearing capability and counterparties can use to drive gross or net settlement. However, current systems do not provide for ongoing calculation of net positions in order to reduce the number of necessary settlements.

### BRIEF SUMMARY

Embodiments of the present invention address these and/or other needs by providing an innovative system operatively connected with a block chain distributed network and for using the block chain distributed network for providing aggregate tracking and threshold triggering.

In some embodiments, the invention is directed to a system for calculating and monitoring a net position between two entities for clearance and settlement on a decentralized block chain. In some embodiments, smart contracts are implemented to track an aggregate amount of the net position and upon reaching a predetermined threshold, trigger settlement between the entities, wherein clearance and settlement are carried out on separate block chains.

Embodiments of the invention relate to a system operatively connected with a block chain distributed network for facilitating real-time clearance aggregate tracking and threshold triggering, the system maintained by an entity, the system comprising: a memory device; a network communication interface; and a processing device operatively coupled to the memory device and the network communication interface, wherein the processing device is configured to execute computer-readable program code to: receive, over a network via the network communication interface, an interaction record associated with a first entity and a second entity, wherein the interaction record comprises a previous interaction and a previous net position; extract, from a node of the block chain distributed network, the previous net position associated with the first entity and the second entity recorded on a block of the block chain distributed network; calculate an updated net position based on the interaction record associated with the first entity and the second entity; communicate the updated net position to one or more other nodes of the block chain distributed network, wherein each of the one or more nodes is configured to store at least a portion of a distributed ledger; monitor, continuously, using a block chain smart contract application, the updated net position, wherein the block chain smart contract application generates a threshold amount for triggering settlement of the updated net position; based on determining that the updated net position has exceeded the threshold amount, trigger settlement of the updated net position; initiate a settlement transfer from the first entity to the second entity, wherein the settlement transfer at least reduces the updated net position below the threshold amount; receive validation of the settlement transfer from a predetermined number of other nodes on the block chain distributed network; and communicate a record of the settlement to the other nodes on the block chain distributed network.

In some embodiments of the invention, the processing device is further configured to execute computer-readable program code to: record settlement between the entity and the second entity on a second distributed ledger different than the distributed ledger.

Other embodiments of the invention relate to a system operatively connected with a block chain distributed network and for using the block chain distributed network for facilitating real-time clearance aggregate tracking and threshold triggering, the system maintained by an entity, the system comprising: a memory device; and a processing device operatively coupled to the memory device, wherein the processing device is configured to execute computer-readable program code to: receive, at a node of a blockchain distributed network, an interaction record associated with an interaction between a payor and a payee, wherein the payor is associated with a payor entity and the payee is associated with a payee entity; access a distributed ledger, wherein the distributed ledger is updated based on communications from the block chain distributed network; determine, from the distributed ledger, a net position between the entity and a third party; determine whether the interaction record is associated with the entity as a payor entity or a payee entity and: if the entity is the payor entity and the third party is the payee entity, debit the net position in the amount of the interaction; and if the entity is the payee entity and the third party is the payor entity, credit the net position in the amount of the interaction, thereby resulting in an updated net position between the entity and the third party; and record the updated net position on the distributed ledger.

In some embodiments of the invention, the processing device is further configured to execute computer-readable program code to: record the interaction record alongside the updated net position on the distributed ledger.

In some embodiments of the invention, the processing device is further configured to execute computer-readable program code to: compare the updated net position to a predetermined threshold; if the updated net position is greater than the predetermined threshold, initiate settlement of an amount associated with the updated net position.

In some embodiments of the invention, the processing device is further configured to execute computer-readable program code to: if the updated net position indicates the entity owes the third party the amount, initiate payment of the amount to the third party.

In some embodiments of the invention, the processing device is further configured to execute computer-readable program code to: if the updated net position indicates the third party owes the entity the amount, initiate request of the amount from the third party.

In some embodiments of the invention, the processing device is further configured to execute computer-readable program code to: determine settlement of the amount has occurred; and update the updated net position based on the settlement.

In some embodiments of the invention, the processing device is further configured to execute computer-readable program code to: record settlement between the entity and the third party on a second distributed ledger different than the distributed ledger.

In some embodiments of the invention, the processing device is further configured to execute computer-readable program code to: determine, from a transaction request, that an alias is associated with the transaction request; access a private alias ledger comprising a listing of a plurality of aliases and a corresponding plurality of account numbers; determine that the alias corresponds to an account number maintained by the entity; and based on determining that the alias corresponds to the account number maintained by the entity, authorize a transaction associated with the transaction request.

In some embodiments of the invention, the processing device is further configured to execute computer-readable program code to: communicate authorization of the transaction to the block chain distributed network.

In some embodiments of the invention, the processing device is further configured to execute computer-readable program code to: update the distributed ledger stored by the system and provide access to the distributed ledger to the block chain distributed network.

In some embodiments of the invention, the processing device is further configured to execute computer-readable program code to: update the distributed ledger with the authorization of the transaction.

Other embodiments of the invention relate to a computer program product for using a block chain distributed network for facilitating real-time clearance aggregate tracking and threshold triggering, the computer program product comprising at least one non-transitory computer readable medium having computer-readable program code portions embodied therein, the computer-readable program code portions comprising: an executable portion configured for receiving, at a node of a blockchain distributed network, an interaction record associated with an interaction between a payor and a payee, wherein the payor is associated with a payor entity and the payee is associated with a payee entity; an executable portion configured for accessing a distributed ledger, wherein the distributed ledger is updated based on communications from the block chain distributed network; an executable portion configured for determining, from the distributed ledger, a net position between the entity and a third party; an executable portion configured for determining whether the interaction record is associated with the entity as a payor entity or a payee entity and: an executable portion configured for debiting the net position in the amount of the interaction if the entity is the payor entity and the third party is the payee entity; and an executable portion configured for crediting the net position in the amount of the interaction if the entity is the payee entity and the third party is the payor entity, thereby resulting in an updated net position between the entity and the third party; and an executable portion configured for recording the updated net position on the distributed ledger.

In some embodiments of the invention, the computer-readable program code portions further comprise: an executable portion configured for recording the interaction record alongside the updated net position on the distributed ledger.

In some embodiments of the invention, the computer-readable program code portions further comprise: an executable portion configured for comparing the updated net position to a predetermined threshold; an executable portion configured for initiating settlement of an amount associated with the updated net position if the updated net position is greater than the predetermined threshold.

In some embodiments of the invention, the computer-readable program code portions further comprise: an executable portion configured for initiating payment of the amount to the third party if the updated net position indicates the entity owes the third party the amount.

In some embodiments of the invention, the computer-readable program code portions further comprise: an executable portion configured for initiating request of the amount from the third party if the updated net position indicates the third party owes the entity the amount.

In some embodiments of the invention, the computer-readable program code portions further comprise: an executable portion configured for determining settlement of the amount has occurred; and an executable portion configured for updating the updated net position based on the settlement.

In some embodiments of the invention, the computer-readable program code portions further comprise: an executable portion configured for recording settlement between the entity and the third party on a second distributed ledger different than the distributed ledger.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1A is a diagram illustrating a centralized clearinghouse network configuration, in accordance with embodiments of the invention;

FIG. 1B is a diagram illustrating a decentralized block chain network configuration, in accordance with embodiments of the invention;

FIG. 2 is a flowchart illustrating a method for providing aggregate tracking and threshold triggering according to embodiments of the invention;

FIG. 3 is a flowchart illustrating a method for providing aggregate tracking and threshold triggering according to embodiments of the invention;

FIG. 4 is a combined diagram and flowchart illustrating a directory services (DS) block chain environment configuration according to embodiments of the invention; and

FIG. 5 is a diagram illustrating a clearance tracking system environment according to embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

An “account” is the relationship that a user has with an entity, such as a financial institution or bank. Examples of accounts include a deposit account, such as a transactional account (e.g., a banking account), a savings account, an investment account, a money market account, a time deposit, a demand deposit, a pre-paid account, a credit account, a non-monetary user profile that includes information associated with the user, or the like. The account is associated with and/or maintained by the entity. “Assets” include accounts of the user and/or other property owned by the user. The assets may be associated with accounts or may be property that is not associated with a specific account. Examples of assets associated with accounts may be accounts that have cash or cash equivalents, or accounts that are funded with or contain property, such as safety despots box account that jewelry, a trust account that is funded with property, or the like. Examples of assets that may not be associated with accounts may be antiques in a user's home, jewelry in a user's home, or the like. “Authentication information” is any information that can be used to identify of a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. An “entity” as used herein may be a financial institution.

To “monitor” is to watch, observe, or check something for a special purpose over a period of time. The “monitoring” may occur periodically over the period of time, or the monitoring may occur continuously over the period of time. In some embodiments, a system may actively monitor a database, wherein the system reaches out to the database and watches, observes, or checks the database for changes, updates, and the like. In other embodiments, a system may passively monitor a database, wherein the database provides information to the system and the system then watches, observes, or checks the provided information. A “transaction” or “interaction” refers to any communication between a user and the financial institution or other entity monitoring the user's activities. For example, a transaction may refer to a purchase of goods or services, a return of goods or services, a payment transaction, a credit transaction, or other interaction involving a user's account.

A “user” may be a financial institution customer (e.g., an account holder or a person who have an account (e.g., banking account, credit account, or the like)). In some embodiments, a “user” may be a financial institution employee (e.g., an underwriter, a project manager, an IT specialist, a manager, an administrator, an internal operations analyst, bank teller or the like) capable of operating the system described herein. For purposes of this invention, the term “user” and “customer” may be used interchangeably. Furthermore, as used herein the term “user device” may refer to any device that employs a processor and memory and can perform computing functions, such as a personal computer or a mobile device, wherein a mobile device is any mobile communication device, such as a cellular telecommunications device (i.e., a cell phone or mobile phone), personal digital assistant (PDA), a mobile Internet accessing device, or other mobile device. Other types of mobile devices may include portable digital assistants (PDAs), pagers, wearable devices, mobile televisions, gaming devices, laptop computers, cameras, video recorders, audio/video player, radio, global positioning system (GPS) devices, or any combination of the aforementioned.

In accordance with embodiments of the invention, the terms “financial institution,” “financial entity,” and “entity” include any organization that processes financial transactions including, but not limited to, banks, credit unions, savings and loan associations, investment companies, stock brokerages, asset management firms, insurance companies and the like. In specific embodiments of the invention, use of the term “bank” is limited to a financial entity in which account-bearing customers conduct financial transactions, such as account deposits, withdrawals, transfers and the like. In some embodiments, a “user” or “entity” may refer to a financial institution.

### Block Chain Configuration/Architecture

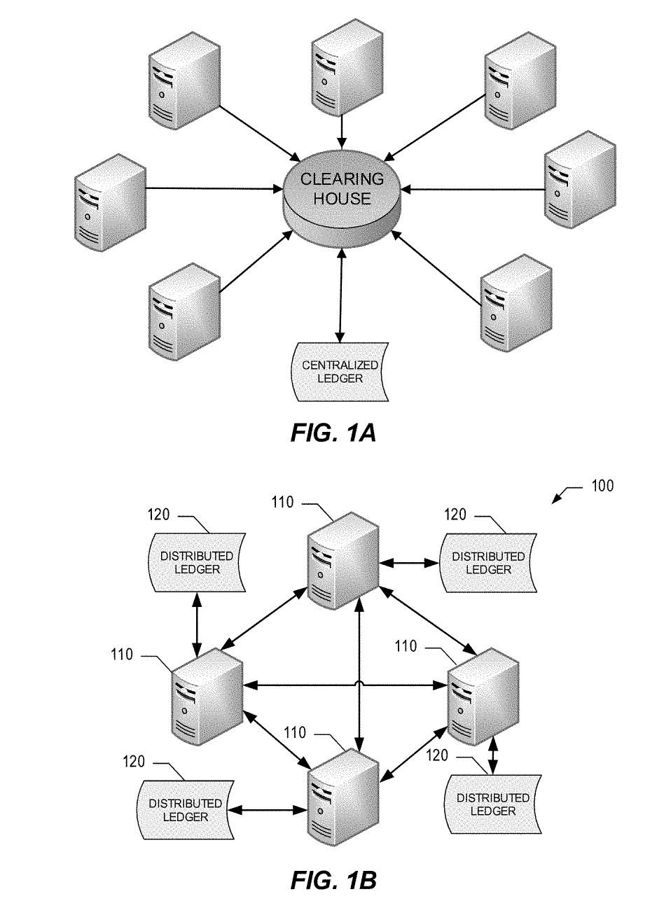

Rather than utilizing a centralized database of aliases as discussed with reference to some embodiments above and as shown in FIG. 1A, other various embodiments of the invention may use a decentralized block chain configuration or architecture as shown in FIG. 1B in order to facilitate aggregate tracking (updated net positions) and threshold triggering (of settlements between institutions).

A block chain or blockchain is a distributed database that maintains a list of data records, the security of which is enhanced by the distributed nature of the block chain. A block chain typically includes several nodes, which may be one or more systems, machines, computers, databases, data stores or the like operably connected with one another. In some cases, each of the nodes or multiple nodes are maintained by different entities. A block chain typically works without a central repository or single administrator. One well-known application of a block chain is the public ledger of transactions for cryptocurrencies such as used in bitcoin. The data records recorded in the block chain are enforced cryptographically and stored on the nodes of the block chain.

A block chain provides numerous advantages over traditional databases. A large number of nodes of a block chain may reach a consensus regarding the validity of a transaction contained on the transaction ledger. Similarly, when multiple versions of a document or transaction exits on the ledger, multiple nodes can converge on the most up-to-date version of the transaction. For example, in the case of a virtual currency transaction, any node within the block chain that creates a transaction can determine within a level of certainty whether the transaction can take place and become final by confirming that no conflicting transactions (i.e., the same currency unit has not already been spent) confirmed by the block chain elsewhere.

The block chain typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person, and blocks are created by users known as “miners” who use specialized software/equipment to create blocks. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases, one that meets other criteria. In some block chain systems, miners are incentivized to create blocks by a rewards structure that offers a predefined per-block reward and/or fees offered within the transactions validated themselves. Thus, when a miner successfully validates a transaction on the block chain, the miner may receive rewards and/or fees as an incentive to continue creating new blocks.

As mentioned above and referring to FIG. 1B, a block chain 100 is typically decentralized—meaning that a distributed ledger 120 (i.e., a decentralized ledger) is maintained on multiple nodes 110 of the block chain 100. One node in the block chain may have a complete or partial copy of the entire ledger or set of transactions and/or blocks on the block chain. Transactions are initiated at a node of a block chain and communicated to the various nodes of the block chain. Any of the nodes can validate a transaction, add the transaction to its copy of the block chain, and/or broadcast the transaction, its validation (in the form of a block) and/or other data to other nodes. This other data may include time-stamping, such as is used in cryptocurrency block chains.

Various other specific-purpose implementations of block chains have been developed. These include distributed domain name management, decentralized crowd-funding, synchronous/asynchronous communication, decentralized real-time ride sharing and even a general purpose deployment of decentralized applications.

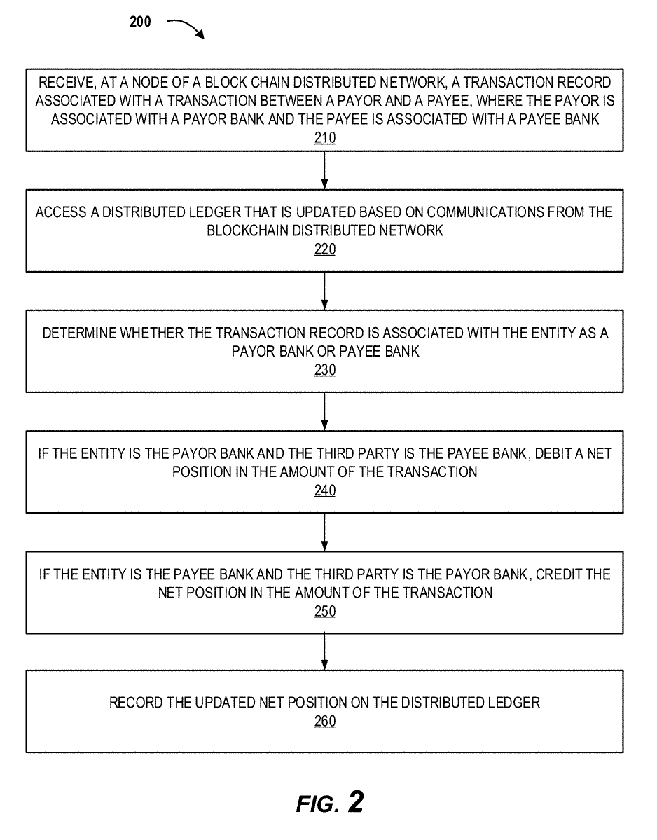

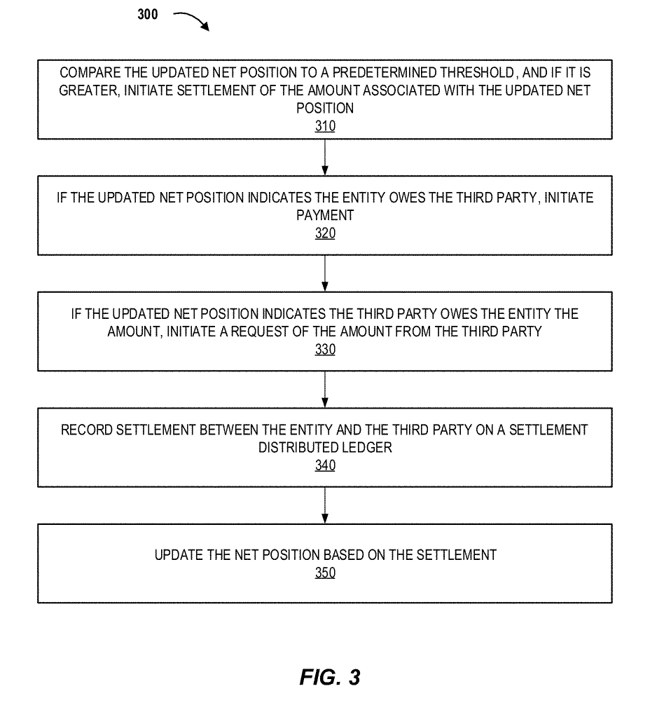

The block chain 100 may also perform one or more of the steps or functions performed by the system as discussed with reference to FIGS. 2 and 3.

### Aggregate Tracking and Threshold Triggering

Various embodiments provide a system operatively connected with a block chain distributed network and for using the block chain distributed network for providing aggregate tracking and threshold triggering. Embodiments receive, at a node of a blockchain distributed network, a transaction record associated with a transaction between a payor and a payee, wherein the payor is associated with a payor bank and the payee is associated with a payee bank; accesses a distributed ledger, wherein the distributed ledger is updated based on communications from the block chain distributed network; determines, from the distributed ledger, a net position between the entity and a third party; determines whether the transaction record is associated with the entity as a payor bank or a payee bank and, if the entity is the payor bank and the third party is the payee bank, debit the net position in the amount of the transaction; and, if the entity is the payee bank and the third party is the payor bank, credit the net position in the amount of the transaction, thereby resulting in an updated net position between the entity and the third party; and records the updated net position on the distributed ledger.

In various embodiments of the invention, existing payment networks (such as EWS, TCH, debit networks, etc.) may be combined with a distributed ledger technology (DLT)-based clearing chain (or blockchain) associated with one or more entity-third party relationships. In some embodiments, another blockchain provides a settlement ledger between an entity and one or more third parties. In some such embodiments, one or more smart contracts dictate the interaction between the block chains by enabling rules that dictate one or more thresholds for comparing net positions between the entity-third party pairs so that settlements may be initiated when thresholds are passed. Payment messages are delivered on existing networks and are also sent to the clearing blockchain. In some embodiments, within the blockchain, transactions are recorded and net positions are calculated from an entity to each counterparty.

In various embodiments, a variety of triggers may initiate settlement of a net position between an entity and a third party. Such triggers may be implemented by one or more smart contracts and may include government regulations, public information such as interest rates or the like, and/or private information known to the entity because of its relationship with a third party. For example, the government may dictate that a particular institution may only have a first level of exposure, and rules may implement the first level of exposure by a smart contract that compares the net position to the first level and initiates a settlement if the net position exceeds the threshold.

This type of configuration provides a more efficient process for interaction between institutions as the number of settlements between the institutions may be drastically reduced. This is because, currently, institutions may be transferring a first amount from the first entity to a second entity and the second entity may be transferring a second amount from the second entity to the first entity. The present invention solves this technical problem commonly found in many modern systems by eliminating the need to calculate multiple settlement amounts by instead tracking and calculating a single net position between two entities and thereby improving the clearance process. This results in a technical improvement to the systems of both entities by eliminating the number of necessary actions required during the settlement process allowing for processing and memory resources to be redirected to other tasks. If a net position had been calculated, then only one transfer would have been necessary, or possibly none if the net position was low enough not to trigger a settlement. Any payment network that allows payments to be sent from bank to bank may be used for settlement in conjunction with embodiments of the invention, and in fact, such payment network may be or include a previously existing network such as a credit card network, automated clearing house (ACH) network, wire network or any other network.

FIG. 2 shows a flowchart illustrating a method for providing aggregate tracking and threshold triggering according to embodiments of the invention. The first step, as represented by block 210, is to receive, at a node of a blockchain distributed network, a transaction record, or interaction record, associated with a transaction or interaction between a payor and a payee. The payor is associated with a payor bank and the payee is associated with a payee bank. In some embodiments, the transaction record may be associated with a clearance transaction between two or more entities such as banks. In some embodiments, the clearance transaction between the two or more entities involves clearing one or payments associated with clients of the two or more banks, wherein payment amounts are owed form one entity to another entity on behalf of the clients.

A transaction record, or block, is generated upon participants using the block chain in its normal way, such as by conducting a transaction. As previously discussed, a transaction can be initiated at any node on the block chain, wherein it is communicated to and stored on various other nodes of the chain. In some embodiments, the system may receive a transaction record as a result of the payor, payee, and/or some other entity conducting a financial transaction. In some embodiments, the financial transaction conducted between the payor, payee, and/or other entity triggers the generation of a transaction record. In some embodiments, transaction records or block require validation at other nodes on the block chain, wherein a predetermined number of nodes are required to validate the transaction record. For example, for a transaction record to be considered valid, three or more other nodes may be required to validate the transaction. In some embodiments, the system may extract from a node or block in the distributed network block chain a previous transaction or interaction, wherein the previous transaction contains a previous net position associated with the entities.

The next step, as represented by block 220, is to access a distributed ledger that is updated based on communications from the blockchain distributed network. In some embodiments, the ledger is a set of one or more transactions and/or blocks associated with the payor and the payee. In some embodiments, one node on the blockchain may have a partial or complete record of the ledger. In other embodiments, the ledger is decentralized and distributed across multiple nodes on the block chain which maintain the decentralized ledger. In some embodiments, the distributed ledger is a collection of one or more transaction conducted between the payor and the payee. In some embodiments, the transactions collected in the distributed ledger are pending and have not yet been settled between the payor and the payee, wherein the settlement of the pending transactions between involved entities is executed at a later predetermined time or regularly scheduled time interval. For example, a first entity may conduct several transactions with a second entity over the course of a month, wherein at the end of the month, the total amount for the previously conducted transactions is collected by the second entity from the first entity and, therefore, the amount of the transaction is cleared. In some embodiments, a first entity and a second entity may both owe an amount for one or more transactions to each other. For example, the first entity may owe the second entity a first amount while the second entity may owe the first entity a second amount, wherein the first entity and the second entity may wish to clear these owed amounts simultaneously.

In some embodiments, upon accessing the distributed ledger, the system determines a net position between an entity and a third party, wherein one of the entity and third party may be either the payor bank, the payee bank, or some other entity involved in a clearance process. The net position, in some embodiments, is a running balance of the amount of the transactions between the payor and the payee. In some embodiments, the net position may be continuously monitored by the system and updated in real time to reflect recent transactions between the payor and the payee. In some embodiments, the net position

Next, as represented by block 230, the system determines whether the transaction record is associated with the entity as a payor bank or payee bank. Then, if the entity is the payor bank and the third party is the payee bank, the system debits a net position in the amount of the transaction, thereby maintaining an accurate, ongoing net position between the entity and the third party, as represented by block 240. For example, from the point of view of the payor bank, an amount is added to the net position in favor of the payee bank for the amount that the payor bank owes the payee bank.

Next, if the entity is the payee bank and the third party is the payor bank, the system credits the net position in the amount of the transaction, as represented by block 250. In both blocks 240 and 250, the net position, or running ledger, for the total amount owed between the entities is either credited or debited in favor of one of the entities. The system calculates an updated net position based on the credited or debited amount.

In some embodiments, a net position may be monitored between a first entity and multiple other entities. In other embodiments, a net position may be monitored for multiple pairs of entities. In some embodiments, a single block chain may be used to monitor and update a net position between two entities. In other embodiments, a single block chain may be employed to monitor and update one or more net positions between one or more pairs of entities. In yet other embodiments, a single block chain may be used to monitor a net position with one or more particular entities of interest, while all other entities are monitored on a separate block chain. For example, a first bank may wish to monitor a net position with another large national bank on a single, separate block chain due to the high volume of transactions with the large national bank. At the same time, the first bank may collectively monitor one or more net positions with one or more smaller banks on one or more separate block chains due to a lower volume of transactions. In this way, multiple entity-third party net positions may be maintained on a single or multiple clearance block chains.

Finally, as represented by block 260, the system records the updated net position on the distributed ledger (i.e., blockchain). In this way, the net position is continuously monitored and maintained by the system. In some embodiments, the system references a block containing the last transaction conducted and/or the net position at the time of the last transaction in order to obtain and update the net position after a recent transaction. In some embodiments, the system further communicates the updated net position amount to one or more other nodes on the distributed block chain network.

FIG. 3 shows a flowchart illustrating a method for providing aggregate tracking and threshold triggering according to embodiments of the invention. First, as represented by block 310, the system compares the updated net position to a predetermined threshold. If it is greater than the threshold, the system initiates settlement of the amount associated with the updated net position. In some embodiments of the invention, the processes of clearance and settlement are separate processes carried out on separate block chains, wherein settlement is carried out on a settlement block chain based on a net position being updated on a clearance block chain.

Thresholds are predetermined limits for the net position to reside within, whereupon the net position exceeding a threshold results in the triggering of settlement and/or other actions between two or more entities. In some embodiments, a threshold may be an amount, wherein upon determination by the system that the net position exceeds the threshold amount, the system triggers settlement of the amount for the net position between the two or more entities. In some embodiments, the threshold may be time related, wherein settlement is triggered after a predetermined length of time. For example, settlement may be automatically triggered by the system at the end of a fiscal quarter or after a different length of time.

In other embodiments, threshold triggers may include government regulations, public information such as interest rates or the like, and/or private information known to the entity because of its relationship with a third party. For example, the government may dictate that a particular institution may only have a first level of exposure, and rules may implement the first level of exposure and compare the net position to the first level and initiate a settlement if the net position exceeds the threshold

In some embodiments of the invention, multiple predetermined thresholds may be used to monitor a net position. In this way, if the conditions for a first threshold are not met, the conditions of a second threshold may be met in order to trigger settlement of a net position between entities. For example, the monitoring between two entities may stipulate a first threshold which sets a predetermined limit on the amount that the net position is allowed to reach. At the same time, a second threshold setting forth a predetermined time before settlement is automatically triggered may also be included in the monitoring. In this way, even if the amount of the net position does not reach the predetermined limit, settlement of the net position amount may still be triggered as a result of the predetermined time having expired.

Thresholds and/or triggers for settlement may be implemented by one or more smart contracts to monitor an updated net position. In some embodiments, monitoring and implementation of smart contract thresholds is carried out by the block chain smart contract application. As noted above, smart contracts may also be implemented on the blockchain and may be used, for example, to coordinate a relationship between a clearance blockchain and a settlement blockchain and one or more net positions and triggers for settlement between one or more entity—third party pairs. Smart contracts are computer processes that facilitate, verify and/or enforce negotiation and/or performance of a contract between parties. One fundamental purpose of smart contracts is to integrate the practice of contract law and related business practices with electronic commerce protocols between people on the Internet. Smart contracts may leverage a user interface that provides one or more parties or administrators access, which may be restricted at varying levels for different people, to the terms and logic of the contract. Smart contracts typically include logic that emulates contractual clauses that are partially or fully self-executing and/or self-enforcing. Examples of smart contracts are digital rights management (DRM) used for protecting copyrighted works, financial cryptography schemes for financial contracts, admission control schemes, token bucket algorithms, other quality of service mechanisms for assistance in facilitating network service level agreements, person-to-person network mechanisms for ensuring fair contributions of users, and others.

Smart contract infrastructure can be implemented by replicated asset registries and contract execution using cryptographic hash chains and Byzantine fault tolerant replication. For example, each node in a peer-to-peer network or blockchain distributed network may act as a title registry and escrow, thereby executing changes of ownership and implementing sets of predetermined rules that govern transactions on the network. Each node may also check the work of other nodes and in some cases, as noted above, function as miners or validators.

The customer can use the services of the node to create a smart contract. This smart contract, as noted above, is a set of rules which, when executed by the blockchain at a specific time, will return the best alias/rail to choose for a particular payment. This is useful in a scenario where an alias maps to multiple tokens. The smart contract returns the best token that a sender (node) can use to make a particular payment. For example, if ABCDE is an alias for multiple tokens, then the sender wants to make a cross-border payment, the smart contract may execute a set of rules as set by the customer (who is the recipient) and return the token and the appropriate rail through which the customer wants to receive cross-border payments. As another example, if the sender wants to make a real-time payment, then the smart contract may choose a token-rail combination that supports real-time payments.

Referring now back to FIG. 3, as represented by block 320, if the updated net position indicates the entity owes the third party, the system initiates payment. Alternatively, as represented by block 330, if the updated net position indicates the third party owes the entity the amount, the system initiates a request of the amount from the third party. During settlement, the system initiates a transfer of funds or assets from the accounts of one entity to those of another entity. In this way, the system eliminates the need for the monitoring and payment of separate amounts during settlement between entities. Instead of a first entity making a first payment to a second entity and the second entity making a second payment to the first entity in return in order to settle owed amounts, a single net payment may be made based on determining the net position with respect to the amounts owed between the two entities. For example, a first entity may owed a second entity $10,000, while the second entity owes the first entity $9,000. In this example, the present invention calculates a net position of $1,000 owed to the second entity and allows for the single payment of the amount of $1,000 to be paid by the first entity to the second entity instead of both entities paying each other for the same amount. This results in an improvement to the financial systems of both entities by eliminating the number of necessary actions required during the settlement process allowing for processing and memory resources to be redirected to other tasks.

Next, FIG. 3 further shows that the system then records the settlement between the entity and the third party on a settlement distributed ledger different than the clearance distributed ledger, as represented by block 340. As previously discussed, in some embodiments of the invention, clearance and settlement may be separate process carried out on separate block chains. In other embodiments, clearance and settlement may be a single process that is carried out on a single block chain.

Finally, as represented by block 350, the system updates the net position based on the settlement. In some embodiments, the system settles and updates the net position based on one or more thresholds, wherein the amount of the threshold is settled. In other embodiments, upon reaching a threshold amount, the entirety of the net position, even that exceeding the threshold, may be settled between the two entities. In other embodiments, the system settles the net position for an amount that at least reduces the net position so that is below the threshold amount. In yet other embodiments, the system settles the net position for the amount of the threshold upon the threshold being reached. In some embodiments, the settlement transfer is validated by a predetermined number of other nodes on the block chain distributed network and the record is communicated to the other nodes on the block chain.

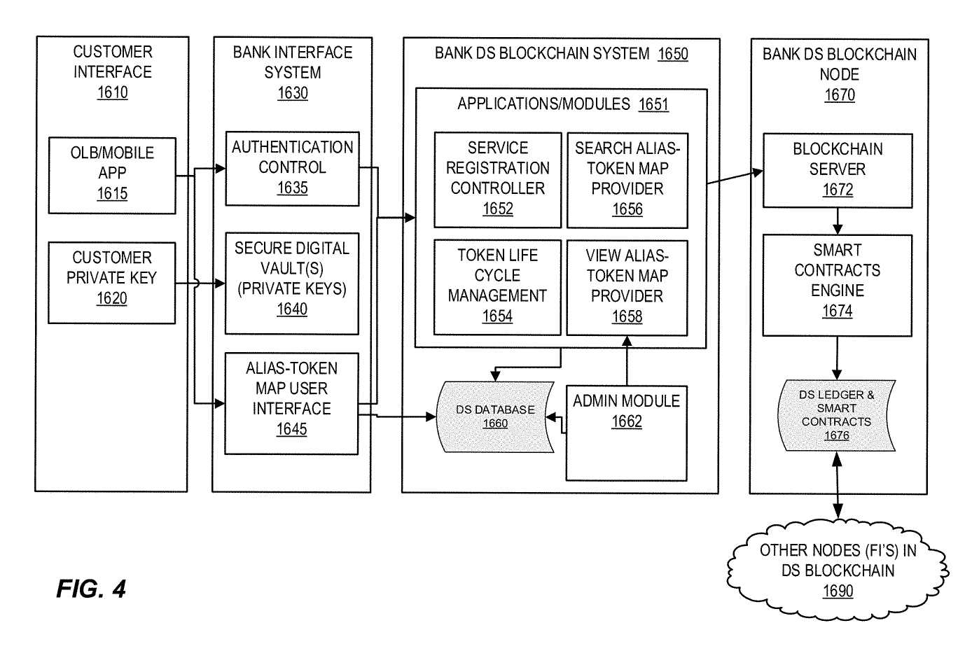

Referring to FIG. 4, a combined diagram and flowchart illustrates a blockchain distributed network system environment configured for alias mapping according to some embodiments of the invention. In various embodiments, payment messages related to an alias-based transaction are sent to the clearing blockchain discussed above. A customer interface 1610 enables a customer to interact with a financial institution by use of an online banking and/or mobile application (OLB/mobile app) 1615. The customer interface 1610 is configured to operably connect with the bank interface system 1630. The bank interface system 1630 may have an authentication control module 1635 for authenticating the customer's identity with the financial institution through the customer interface 1610. An alias-token map user interface 1645 enables the customer to manage their aliases and register new alias-token pairs. The bank interface system 1630 is operably connected with the bank DS blockchain system 1650, which in some cases is one or more systems or servers internal to the financial institution, that is, without direct access to systems external to the financial institution.

The bank Directory Services (DS) blockchain system 1650, in some embodiments, includes several applications or modules 1651. These modules may include a service registration controller 1652, a token life cycle management module 1654, a search alias-token map provider module 1656 and a view alias-token map provider module 1658. The service registration controller 1652 enables a customer to map an alias to a token (i.e., account or financial instrument) that is held by the financial institution. The token life cycle management module 1654 enables a customer to manage his/her aliases and the alias-token mappings. Module 1654 allows the customer to edit the alias and/or token that has been mapped, to add new aliases and tokens and their mappings, and to delete aliases, token and/or mappings from the customer's account. The search alias-token map provider module 1656 is configured to enable the financial institution to process a payment. The financial institution must search the blockchain using the module 1656 to identify account details associated with any alias that is submitted to the financial institution for a payment transaction. The view alias-token map provider 1658 enables the customer to view all the details regarding mappings. The system 1650 has a bank database 1660, which may include information related to some or all the financial institution's accounts, customer and/or the like. The admin module 1662 controls access permissions and may initiate and/or manage running of the other modules 1651.

Every bank or financial institution that is participating in the DS blockchain has a node that is an interface for connecting with and communicating with the blockchain. The bank DS blockchain node 1670 has a blockchain server 1672 that is configured to connect the node 1670 with the blockchain. A smart contracts engine 1674 is provided for implementing smart contracts for managing alias-token selection for processing payments. For example, given a particular set of circumstances, the smart contract may be configured to use a particular alias-token pair for completing a payment. Some or all the data stored in the bank database 1660 may be pushed to the DS ledger and smart contract database 1676 that is provided for access by the blockchain network, represented by the other nodes (e.g., financial institutions) in the DS blockchain cloud 1690. In some cases, the bank database 1660 may contain more information for a particular alias-token mapping pair than is pushed to the DS ledger 1676. For example, the alias-token pair may be associated with a customer name, bank name, financial institution name, payment rail, rail fee and/or the like.

The customer private key 1620 may be created and provided by the service registration controller 1652. The customer may select to store the secure digital vault(s) 1640. These private key(s), as discussed elsewhere, provide the customer with an opportunity to access his or her account through the originating financial institution or another financial institution. In some embodiments, the system may use the customer private key and/or alias to determine a corresponding account number and authorize a transaction associated with a transaction request. In further embodiments of the invention, the authorization of the transaction may further provide access to a distributed ledger on the block chain distributed network, wherein the distributed ledger may be updated with the authorization of the transaction.

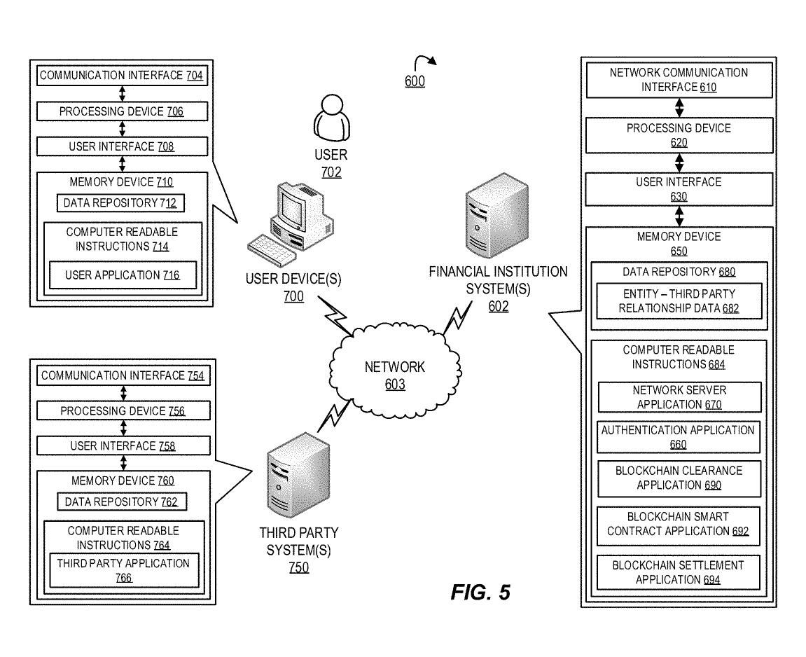

Referring to FIG. 5, the figure illustrates a clearance tracking system environment 600, in accordance with some embodiments of the invention. The environment 600 includes a user device 700 associated or used with authorization of a user 702, a financial institution system 602, and a third party system 750. As used herein, a “processing device,” such as the processing devices 620, 706, and 756 generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may further include functionality to operate one or more software programs based on computer-executable program code thereof, which may be stored in a memory. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “user interface” such as the user interfaces 630, 708, and 758 generally includes a plurality of interface devices and/or software that allow a customer to input commands and data to direct the processing device to execute instructions. For example, the user interfaces presented in FIG. 5 may include a graphical user interface (GUI) or an interface to input computer-executable instructions that direct the processing device to carry out specific functions. The user interface employs certain input and output devices to input data received from a user or output data to a user. These input and output devices may include a display, mouse, keyboard, button, touchpad, touch screen, microphone, speaker, LED, light, joystick, switch, buzzer, bell, and/or other customer input/output device for communicating with one or more customers.

As used herein, a “memory device” such as memory devices 650, 710, and 760 generally refers to a device or combination of devices that store one or more forms of computer-readable media for storing data and/or computer-executable program code/instructions. Computer-readable media is defined in greater detail below. For example, in one embodiment, the memory device includes any computer memory that provides an actual or virtual space to temporarily or permanently store data and/or commands provided to the processing device when it carries out its functions described herein.

As used herein, a “communication interface” generally includes a modem, server, transceiver, and/or other device for communicating with other devices on a network, and/or a user interface for communicating with one or more customers. Referring again to FIG. 5, the network communication interface 610 as well as communication interfaces 704 and 754 are communication interfaces having one or more communication devices configured to communicate with one or more other devices on a network, such as a mobile device, a personal computing device, a mobile banking system, other financial institution banking systems, an alias data repository, and/or the like. The processing device is configured to use the network communication interface to transmit and/or receive data and/or commands to and/or from the other devices connected to the network.

The systems and devices communicate with one another over the network 603 and perform one or more of the various steps and/or methods according to embodiments of the disclosure discussed herein. The network 603 may include a local area network (LAN), a wide area network (WAN), and/or a global area network (GAN). The network 603 may provide for wireline, wireless, or a combination of wireline and wireless communication between devices in the network. In one embodiment, the network 130 includes the Internet.

The user device 700 includes a communication interface 704 communicably coupled with a processing device 706, which is also communicably coupled with a memory device 710. In some embodiments, the communication interface 704 may also comprise a GPS transceiver capable of determining a geographic location associated with the user device 700. The processing device 706 is configured to control the communication interface 704 such that the user device 700 communicates across the network 603 with one or more other systems. The processing device 706 is also configured to access the memory device 710 in order to read the computer readable instructions 714, which in some embodiments includes a user application 716. The user application 716 allows for communication of the user device 700 with the other systems and devices within the environment 600 such as the third party system 750, and financial institution system 602. The user application 716 allows the user 702 to receive information transmitted as well as input information requested by the other systems and communicate with a financial institution, one or more third parties, and/or other entities. The memory device 710 also includes a data repository 712 or database for storing pieces of data that can be accessed by the processing device 706.

The third party system 750 includes a communication interface 754 communicably coupled with a processing device 756, which is also communicably coupled with a memory device 760. The processing device 756 is configured to control the communication interface 754 such that the third party system 750 communicates across the network 603 with one or more other systems. The processing device 756 is also configured to access the memory device 760 in order to read the computer readable instructions 764, which in some embodiments includes a third party application 766. The third party application 766 allows for communication with the other systems and devices within the environment 600 such as the user device 700 and the financial institution system 602. The memory device 760 also includes a data repository 762 or database for storing pieces of data that can be accessed by the processing device 756.

The financial institution system 602 may be a single system or multiple systems networked with one another to perform one or more process steps discussed herein. As illustrated in FIG. 5, in one embodiment of the invention, the financial institution system 602 includes a processing device 620 operatively coupled to a network communication interface 610 and a memory device 650. In certain embodiments, the financial institution system 602 is operated by a first entity, such as a financial institution, while in other embodiments, the financial institution system 602 is operated by an entity other than a financial institution.

It should be understood that the memory device 650 may include one or more databases or other data structures/repositories. The memory device 650 also includes computer-executable program code that instruct the processing device 620 to operate the network communication interface 610 to perform certain communication functions of the financial institution system 602 described herein. For example, in one embodiment of the clearance tracking system environment 600, the memory device 650 includes, but is not limited to, a network server application 670, an authentication application 660, a data repository 680 which includes entity-third party relationship data 682, a blockchain clearance application 690, a blockchain smart contract application 692, a blockchain settlement application 694 and other computer-executable instructions or other data. The computer-executable program code of the network server application 670, the blockchain clearance application 690, the blockchain smart contract application 692, and/or the blockchain settlement application 694 may instruct the processing device 620 to perform certain logic, data-processing, and data-storing functions of the financial institution system 602 described herein, as well as communication functions of the financial institution system 602.

The user application 716, the third party application 766, the blockchain clearance application 690, the network server application 670, the authentication application 660, blockchain smart contract application 692, and the blockchain settlement application 694 are for instructing the processing devices on their respective systems to perform various steps of the methods discussed herein, and/or other steps and/or similar steps. In various embodiments, one or more of the various applications discussed are included in the computer readable instructions stored in a memory device of one or more systems or devices other than their respective systems and/or devices. For example, in some embodiments, the user application 716 is stored and configured for being accessed by a processing device of the financial institution system 602 connected to the network 603. In various embodiments, the user application 716, the third party application 766, and the various applications stored on the financial institution system 602 are stored and executed by different systems/devices. In some embodiments, the discussed applications may be similar and may be configured to communicate with one another. In some embodiments, the various applications may be considered to be working together as a singular application despite being stored and executed on different systems.

In various embodiments, one of the systems discussed above, such as the financial institution system 602, is more than one system and the various components of the system are not collocated, and in various embodiments, there are multiple components performing the functions indicated herein as a single device. For example, in one embodiment, multiple processing devices perform the functions of the processing device 620 of the financial institution system 602 described herein.

In various embodiments, the third party system 750, the financial institution system 602, and the user device 700 and/or other systems may perform all or part of a one or more method or process steps discussed above and/or other method steps in association with the method steps discussed above. Furthermore, some or all the systems/devices discussed here, in association with other systems or without association with other systems, in association with steps being performed manually or without steps being performed manually, may perform one or more of the steps of one or more of the method discussed herein, or other methods, processes or steps discussed herein or not discussed herein.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system operatively connected with a block chain distributed network for facilitating real-time clearance aggregate tracking and threshold triggering, the system maintained by an entity, the system comprising:
a memory device;
a network communication interface; and
a processing device operatively coupled to the memory device and the network communication interface, wherein the processing device is configured to execute computer-readable program code to:
receive, over a network via the network communication interface, an interaction record associated with a first entity and a second entity, wherein the interaction record comprises a previous interaction and a previous net position;
extract, from a node of the block chain distributed network, the previous net position associated with the first entity and the second entity recorded on a block of the block chain distributed network;
calculate an updated net position based on the interaction record associated with the first entity and the second entity;
communicate the updated net position to one or more other nodes of the block chain distributed network, wherein each of the one or more other nodes is configured to store at least a portion of a distributed ledger;
monitor, continuously, using a block chain smart contract application, the updated net position, wherein the block chain smart contract application generates a threshold amount for triggering a settlement of the updated net position;
based on determining that the updated net position has exceeded the threshold amount, trigger the settlement of the updated net position;
initiate a settlement transfer from the first entity to the second entity, wherein the settlement transfer at least reduces the updated net position below the threshold amount;
receive validation of the settlement transfer from a predetermined number of the one or more other nodes on the block chain distributed network; and
communicate a record of the settlement to the one or more other nodes on the block chain distributed network.

2. The system of claim 1, wherein the processing device is further configured to execute computer-readable program code to:
record settlement between the entity and the second entity on a second distributed ledger different than the distributed ledger.

3. A system operatively connected with a block chain distributed network and for using the block chain distributed network for facilitating real-time clearance aggregate tracking and threshold triggering, the system maintained by an entity, the system comprising:
a memory device; and
a processing device operatively coupled to the memory device, wherein the processing device is configured to execute computer-readable program code to:
receive, at a node of a blockchain distributed network, an interaction record associated with an interaction between a payor and a payee, wherein the payor is associated with a payor entity and the payee is associated with a payee entity;
access a distributed ledger, wherein the distributed ledger is updated based on communications from the block chain distributed network;
determine, from the distributed ledger, a net position between the entity and a third party;
determine whether the interaction record is associated with the entity as the payor entity or the payee entity and:
if the entity is the payor entity and the third party is the payee entity, debit the net position in an amount of the interaction; and
if the entity is the payee entity and the third party is the payor entity, credit the net position in the amount of the interaction,
thereby resulting in an updated net position between the entity and the third party; and
record the updated net position on the distributed ledger.

4. The system of claim 3, wherein the processing device is further configured to execute computer-readable program code to:
record the interaction record alongside the updated net position on the distributed ledger.

5. The system of claim 3, wherein the processing device is further configured to execute computer-readable program code to:
compare the updated net position to a predetermined threshold;
if the updated net position is greater than the predetermined threshold, initiate settlement of an amount associated with the updated net position.

6. The system of claim 5, wherein the processing device is further configured to execute computer-readable program code to:
if the updated net position indicates the entity owes the third party the amount, initiate payment of the amount to the third party.

7. The system of claim 5, wherein the processing device is further configured to execute computer-readable program code to:
if the updated net position indicates the third party owes the entity the amount, initiate request of the amount from the third party.

8. The system of claim 5, wherein the processing device is further configured to execute computer-readable program code to:
determine settlement of the amount has occurred; and
update the updated net position based on the settlement.

9. The system of claim 8, wherein the processing device is further configured to execute computer-readable program code to:
record settlement between the entity and the third party on a second distributed ledger different than the distributed ledger.

10. The system of claim 3, wherein the processing device is further configured to execute computer-readable program code to:
determine, from a transaction request, that an alias is associated with the transaction request;
access a private alias ledger comprising a listing of a plurality of aliases and a corresponding plurality of account numbers;
determine that the alias corresponds to an account number maintained by the entity; and
based on determining that the alias corresponds to the account number maintained by the entity, authorize a transaction associated with the transaction request.

11. The system of claim 10, wherein the processing device is further configured to execute computer-readable program code to:
communicate authorization of the transaction to the block chain distributed network.

12. The system of claim 10, wherein the processing device is further configured to execute computer-readable program code to:
update the distributed ledger stored by the system and provide access to the distributed ledger to the block chain distributed network.

13. The system of claim 12, wherein the processing device is further configured to execute computer-readable program code to:
update the distributed ledger with the authorization of the transaction.

14. A computer program product for using a block chain distributed network for facilitating real-time clearance aggregate tracking and threshold triggering, the computer program product comprising at least one non-transitory computer readable medium having computer-readable program code portions embodied therein, the computer-readable program code portions comprising:
an executable portion configured for receiving, at a node of a blockchain distributed network, an interaction record associated with an interaction between a payor and a payee, wherein the payor is associated with a payor entity and the payee is associated with a payee entity;
an executable portion configured for accessing a distributed ledger, wherein the distributed ledger is updated based on communications from the block chain distributed network;
an executable portion configured for determining, from the distributed ledger, a net position between an entity and a third party;
an executable portion configured for determining whether the interaction record is associated with the entity as the payor entity or the payee entity and:
an executable portion configured for debiting the net position in an amount of the interaction if the entity is the payor entity and the third party is the payee entity; and
an executable portion configured for crediting the net position in the amount of the interaction if the entity is the payee entity and the third party is the payor entity,
thereby resulting in an updated net position between the entity and the third party; and
an executable portion configured for recording the updated net position on the distributed ledger.

15. The computer program product of claim 14, wherein the computer-readable program code portions further comprise:
an executable portion configured for recording the interaction record alongside the updated net position on the distributed ledger.

16. The computer program product of claim 14, wherein the computer-readable program code portions further comprise:
an executable portion configured for comparing the updated net position to a predetermined threshold;
an executable portion configured for initiating settlement of an amount associated with the updated net position if the updated net position is greater than the predetermined threshold.

17. The computer program product of claim 16, wherein the computer-readable program code portions further comprise:
an executable portion configured for initiating payment of the amount to the third party if the updated net position indicates the entity owes the third party the amount.

18. The computer program product of claim 16, wherein the computer-readable program code portions further comprise:
an executable portion configured for initiating request of the amount from the third party if the updated net position indicates the third party owes the entity the amount.

19. The computer program product of claim 16, wherein the computer-readable program code portions further comprise:
an executable portion configured for determining settlement of the amount has occurred; and
an executable portion configured for updating the updated net position based on the settlement.

20. The computer program product of claim 19, wherein the computer-readable program code portions further comprise:
an executable portion configured for recording settlement between the entity and the third party on a second distributed ledger different than the distributed ledger.
